(19) United States
(12) Patent Application Publication
(10) Pub. No.: US 2008/0271926 A1
(43) Pub. Date: Nov. 6, 2008

(54) MOUNTING SYSTEM FOR A FIBER OPTIC CABLE AT A DOWNHOLE TOOL

(75) Inventors: Martin P. Coronado, Cypress, TX (US); Stephen L. Crow, Kingwood, TX (US); Vinay Varma, Houston, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 11/744,301

(22) Filed: May 4, 2007

(51) Int. Cl. E21B 10/44; E03B 3/18; E21B 17/10; E21B 47/00; G02B 6/44

(52) U.S. Cl. 175/323; 166/227; 175/325.1; 385/100; 73/152.54; 166/242.2

(57) ABSTRACT

Disclosed herein is a fiber optic cable downhole tool mounting system. The system includes, a downhole tool, a support member attached to the downhole tool and a fiber optic cable parameter transmissively mounted to the downhole tool by the support member. The support member has an elongated body with a pair of legs extending therefrom, the pair of legs intersect at an oblique angle and define a volume therebetween receptive of the fiber optic cable. The fiber optic cable is attached to the support member and the support member is attached to the downhole tool such that a parameter encountered by the downhole tool is sensible by the fiber optic cable.

### BACKGROUND OF THE INVENTION

Downhole tools are used in the hydrocarbon production industry for a variety of purposes, one such purpose is a gravel pack. Gravel packs including screen assemblies are commonly used in wells and are known in the hydrocarbon production industry for minimizing production of undesirable particles, such as sand, with hydrocarbon production.

The environment in which screen assemblies are employed can be severe and as such screen assemblies are susceptible to damage and failure. One condition sometimes encountered downhole is a condition known as “compaction.”Compaction is a process that brings about an increase in soil density or unit weight, accompanied by a decrease in fluid volume. When compaction occurs in a hydrocarbon well it increases stress and strain on the well and can sometimes lead to damage or even failure of an employed downhole tool such as a screen assembly, for example. Failure of a tool in a well or damage to such tool, depending upon the extent, can have a detrimental affect on hydrocarbon production and can be costly to repair. In view hereof, information about various parameters, of which stress and strain are only two, experienced by the downhole tool being considered is valuable to ensure that appropriate repair or reconstruction will be effected at the appropriate time. In addition, such information will provide the industry with a knowledge base regarding failure modes for downhole tools such as screens, the existence of which will facilitate further engineering advances for such tools malting them more robust. A partial list of measurable parameters includes stress, strain, temperature, seismic activity, chemical composition, pressure and combinations thereof.

Strain, for example, experienced by a downhole tool can be measured by monitoring the frequency shift in a fiber optic cable that is positioned to experience the same strain. Supporting cables therefore at the downhole tool of interest is a valuable endeavor. Since fiber optic cables are subject to damage when employed in the downhole environment such as on a screen, and especially while the screen is being run into the wellbore, consideration of support and mounting of the cables is important. Accordingly, the industry will well respond to durable mountings of fiber optic cable on downhole tools such as screens.

### BRIEF DESCRIPTION OF THE INVENTION

Disclosed herein is a fiber optic cable downhole tool mounting system. The system includes, a downhole tool, a support member attached to the downhole tool and a fiber optic cable parameter transmissively mounted to the downhole tool by the support member. The support member has an elongated body with a pair of legs extending therefrom, the pair of legs intersect at an oblique angle and define a volume therebetween receptive of the fiber optic cable. The fiber optic cable is attached to the support member and the support member is attached to the downhole tool such that a parameter encountered by the downhole tool is sensible by the fiber optic cable.

Further disclosed herein is a fiber optic cable downhole tool mounting system. The system includes, a downhole tool, an elongated support member with two legs extending from a body at an obtuse angle to one another. At least one of the legs is attached to the downhole tool such that the body is positioned at a greater radial dimension from an axis of the downhole tool than radial dimensions of the legs thereby defining a volume between the support member and the downhole tool and a fiber optic cable strain sensibly mounted within the volume between the support member and the downhole tool such that the fiber optic cable senses strain encountered by the downhole tool.

Further disclosed herein is a fiber optic cable downhole tool mounting system. The system includes, a base pipe, a shroud in axial alignment with the base pipe positioned radially outwardly of the base pipe, at least one tubular member positioned within an annular space between the base pipe and the shroud and a fiber optic cable positioned in an annular space between the base pipe and the shroud. The fiber optic cable is strain transmissively mounted to the downhole tool through interference of the fiber optic cable with at least two of the base pipe, the shroud and the at least one tubular member.

Further disclosed herein is a fiber optic cable downhole tool mounting system. The system includes, a base pipe, at least one tubular member in axial alignment with the base pipe positioned radially outwardly of the base pipe, a shroud positioned within an annular space between the base pipe and the at least one tubular member and a fiber optic cable positioned in an annular space between the base pipe and the at least one tubular member. The fiber optic cable is strain transmissively mounted to the downhole tool through interference of the fiber optic cable with at least two of the base pipe, the shroud and the at least one tubular member.

### BRIEF DESCRIPTION OF THE DRAWINGS

The following descriptions should not be considered limiting in any way. With reference to the accompanying drawings, like elements are numbered alike:

FIG. 1 depicts a fiber optic cable downhole tool mounting system disclosed herein;

FIG. 2 depicts an alternate fiber optic cable downhole tool mounting system in a partially assembled view before end ring attachment to the screen assembly disclosed herein;

FIG. 3 depicts an alternate fiber optic cable downhole tool mounting system disclosed herein;

FIG. 4 depicts a partial cross sectional view of an alternate fiber optic cable downhole tool mounting system disclosed herein;

FIG. 5 depicts a perspective view of the fiber optic cable downhole tool mounting system of FIG. 4;

FIG. 6 depicts an alternate fiber optic cable downhole tool mounting system disclosed herein with a shroud shown partially transparent;

FIG. 7 depicts an alternate fiber optic cable downhole tool mounting system disclosed herein;

FIG. 8 depicts a partial cross sectional view of the fiber optic cable downhole tool mounting system of FIG. 7;

FIG. 9 depicts a cross sectional view of an alternate fiber optic cable downhole tool mounting system disclosed herein in a non-swaged configuration;

FIG. 10 depicts a cross sectional view of the fiber optic cable downhole tool mounting system of FIG. 9 in a swaged configuration;

FIG. 11 depicts a partial cross sectional view of an alternate fiber optic cable downhole tool mounting system disclosed herein; and

FIG. 12 depicts a partial perspective view of the fiber optic cable downhole tool mounting system of FIG. 11.

### DETAILED DESCRIPTION OF THE INVENTION

A detailed description of several embodiments of the disclosed apparatus and method are presented herein by way of exemplification and not limitation with reference to the Figures.

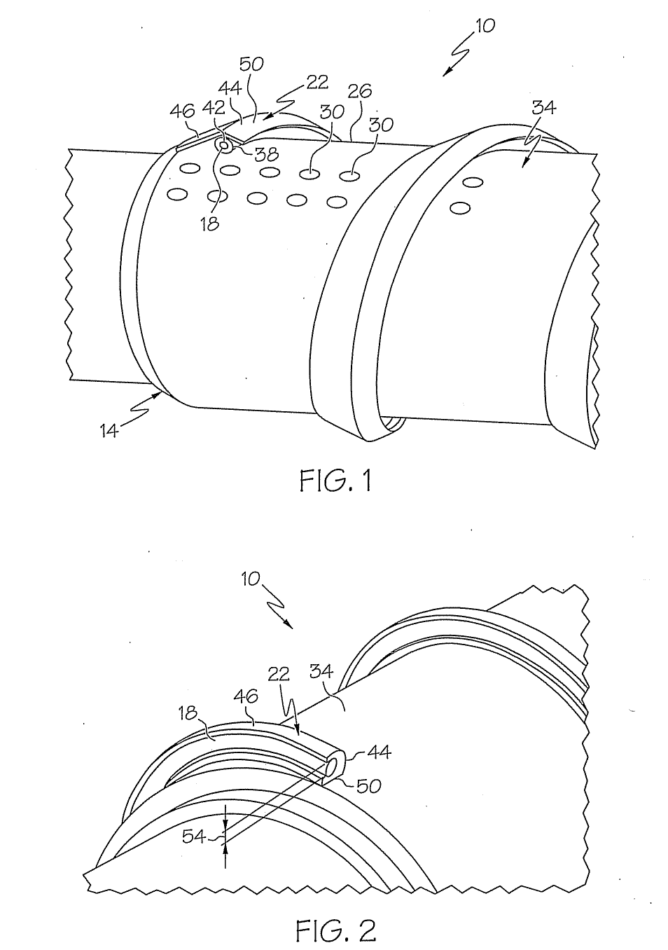

Referring to FIGS. 1-3, three embodiments of the fiber optic cable downhole tool mounting system 10 are illustrated. The mounting system 10 includes among other things, a downhole tool, shown in this embodiment as a screen assembly 14, a fiber optic cable 18 and a support member 22. The screen assembly 14 has a shroud 26 as its radially outermost layer. The shroud 26 has a plurality of apertures 30 (a few of which are shown in FIG. 1) thereon that extend radially through the thickness of the shroud 26. The quantity, location, size and distribution of the apertures 30 can vary and as such is not detailed herein. Both the fiber optic cable 18 and the support member 22 are routed in such a way as to avoid being in direct radial alignment with any of the apertures 30 in the shroud 26. Avoiding radial alignment is done to prevent occluding flow through the apertures 30 and to minimize flow cutting of the fiber optic cable 18 and the support member 22. The fiber optic cable 18 and the support member 22 in this embodiment are routed in a helical pattern on an outer surface 34 of the shroud 26. The fiber optic cable 18 and the support member 22, in these embodiments are attached to the shroud 26 by affixing of the support member 22 to the outer surface 34, such as by welding for example. Alternate embodiments could have the fiber optic cable 18 and the support member 22 attached to the shroud 26 by other means such as by adhesion or swaging, for example. It should be noted that an optional sheath 38 could be used to protect a glass fiber 42 of the fiber optic cable 18. The sheath 38, if used, may be made of a metal such as stainless steel, for example.

A rigid attachment of the fiber optic cable 18 to the shroud 26 is important to assure that the fiber optic cable 18 can accurately sense parameters encountered by the screen assembly 14, such as stress, strain, temperature, seismic activity, chemical composition, pressure and combinations thereof, for example. The attachment of the fiber optic cable 18 to the shroud 26 translates the desired parameter from the shroud 26 to the fiber optic cable 18. Relative motion between the fiber optic cable 18 and the shroud 26 should also be avoided as it could have a detrimental affect on the transmissivity of the mounting system 10. As such, the fiber optic cable 18 can be attached to the support member 22 with an adhesive such as epoxy, for example, or by welding or through swaging of the support member 22 to the fiber optic cable 18. The support member 22 has an elongated body 44 with a pair of legs 46, 50 extending therefrom defining a volume therebetween that is receptive of the fiber optic cable 18. Attachment of the fiber optic cable 18 to the support member 22 could be completed prior to assembly of the support member 22 to the screen assembly 14. The angle of the helical pattern relative to the screen assembly 14, if used, can impact the sensitivity of the parameter sensed by the fiber optic cable 18. Methods for determining specific helical angles are known in the industry and can be employed herein to fit each specific application.

Referring to FIG. 1, the support member 22 in this embodiment has the elongated body 44 made of a long thin metal that could be made by such processes as stamping or extruding, for example. The support member 22 has the first leg 46 and the second leg 50. The first leg 46 and the second leg 50 are angled relative to one another such that when formed into the helical pattern around the outer surface 34 form a support covering for the fiber optic cable 18. Such protection is important, for example, when running a tool string, including the screen assembly 14, into a wellbore. During the run in process it is common for legs of the tool that have the greatest radial dimension to contact the wall of the wellbore as well as other downhole structures. Such contact can damage the portion of the tool making contact if the portion is not strong enough to handle the loads encountered during the contact. The support member 22 disclosed herein is designed to handle the contact loads without experiencing damage that would affect the functional operation of the fiber optic cable 18 that the support member 22 is protecting. In this embodiment the first leg 46 is welded to the outer surface 34 while the second leg 50 is not. A seal can be created by continuously welding the first leg 46 to the outer surface 34 to thereby prevent contamination from wedging between the outer surface 34 and the first leg 46. Similarly, by setting a length of the second leg 50 such that it is close to or in contact with the outer surface 34 contamination can be blocked from wedging between the second leg 50 and the outer surface 34 as well. Alternate embodiments could weld the second leg 50 to the outer surface 34 the fiber optic cable 18 to completely occlude contamination from reaching it.

Referring to FIG. 2, the fiber optic cable downhole tool mounting system 10, in this embodiment, has a support member 22 with a “C” shaped cross-section. An opening 54 of the “C” shaped cross section, defined by the legs 46, 50 extending from the elongated body 44, is large enough to receive the fiber optic cable 18 therein. The fit of the cable 18 within the opening 54 may include some clearance or may include interference therebetween, depending upon assembly methods employed. Additionally, the cable 18 can be fixedly attached to the support member 22 with an adhesive, welding or other means such as by swaging of the support member 22 about the cable 18, for example. Swaging of the support member 22, if employed, may be done prior to or after the support member 22 is welded to the surface 34. In either case, when the support member 22 is attached to the outer surface 34, the leg 46 of the support member 22 is positioned at a greater radial dimension from an axis of the screen assembly 14 than the greatest radial dimension of any portion of the fiber optic cable 18. As such the leg 46 protects the fiber optic cable 18 from directly contacting a wall or other downhole structure of a wellbore within which the tool is run.

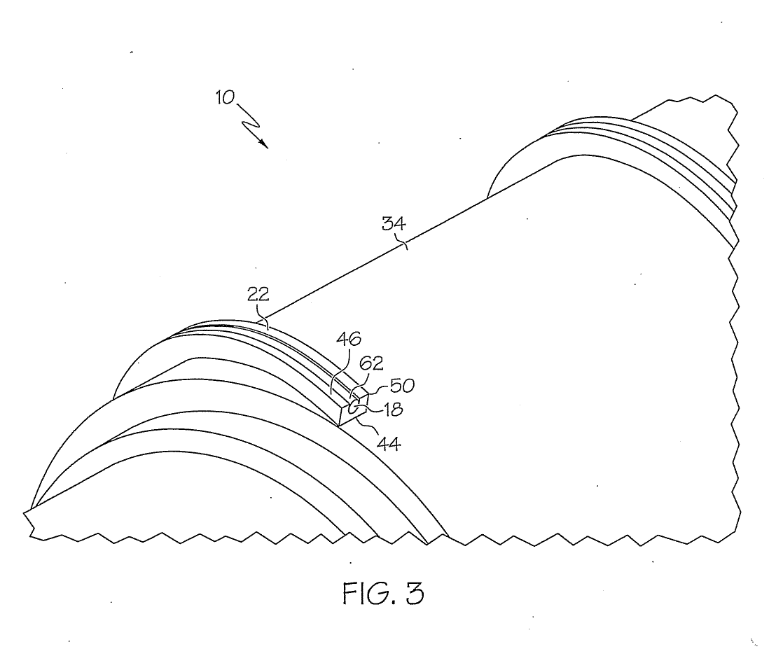

Referring to FIG. 3, the fiber optic cable downhole tool mounting system 10, in this embodiment, also has a support member 22 with a “C” shaped cross-section defined by the legs 46, 50 extending from the elongated body 44 similar to that of FIG. 2. The “C” shaped cross-section in this embodiment, however, is rotated 90 degrees compared to that of FIG. 2, so that an opening 62 between the legs 44, 50 is facing radially outwardly. The fiber optic cable 18 in this embodiment is protected from contacting a wall of a wellbore by the legs 46, 50 of the support member 22, which each extend a greater radial dimension from an axis of the screen assembly 14 than any portion of the fiber optic cable 18.

The foregoing structures of FIGS. 1-3 allow the support member 22 and the fiber optic cable 18 to be fixedly attached to the outer surface 34 while the tool is being run downhole. Doing so includes feeding both the support member 22 and the fiber optic cable 18 in a spiral or helical fashion and welding them to the outer surface 34 during the running of the tool downhole. This embodiment has an advantage of using a continuous fiber optic cable 18 thereby avoiding the splicing of ends of fiber optic cables 18 together as may be necessary when the fiber optic cable 18 is connected to each of a plurality of tubular sections during the manufacture of individual tubular sections.

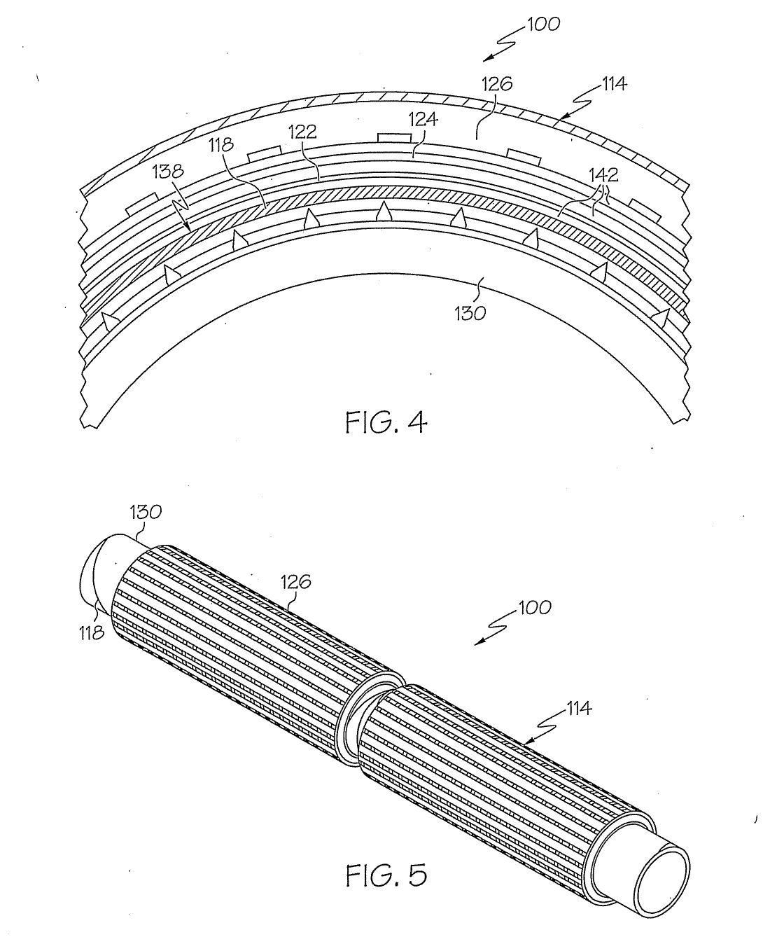

Referring to FIGS. 4 and 5, the fiber optic cable downhole tool mounting system 100, in this embodiment has a screen assembly 114 with a fiber optic cable 118, a support member 122 incorporated therein. The main components of the screen assembly 114 are, a filter media 124, a shroud 126 and a base pipe 130. The fiber optic cable 118 is fixedly attached in this embodiment through swaging of all the layers 122, 124, 126 that are positioned radially outwardly of the fiber optic cable 118. These outer layers 122, 124, 126 and the fiber optic cable 118 are swaged radially inwardly toward the base pipe 130 thereby strain transmissively mounting the fiber optic cable 118 to the base pipe 130. A sheath 138 such as a stainless steel sheath, for example, for covering the glass fiber of the fiber optic cable 118 could be employed to protect the glass fiber during the swaging operation. Additionally, the support member 122 disclosed in this embodiment as a tubular member is an optional layer that may be employed to protect both the fiber optic cable 118 as well as the filter media 124 from damage during the swaging operation. It should be noted that layers other than tubular members could be used in alternate embodiments as the support member 122. An air gap 142 is provided between the layers 122, 124, 126 for ease of assembly and to provide space for movement of material during the swaging operation. Any stresses or other parameter to be measured that may be imparted on the fiber optic cable 118 during the swaging operation can be calibrated to zero after swaging. One advantage of this embodiment is the ability to assemble the fiber optic cable 118 to the screen assembly 114 in a controlled manufacturing environment.

Although the fiber optic cable 118 disclosed herein is positioned radially inwardly of the support member 122 relative to an axis of the tool 100 alternate embodiments could position the fiber optic cable 118 radially outwardly of the support member 122. Still other embodiments could employ two or more support members 122, with some radially inwardly of the fiber optic cable 118 and others radially outwardly of the fiber optic cable 118.

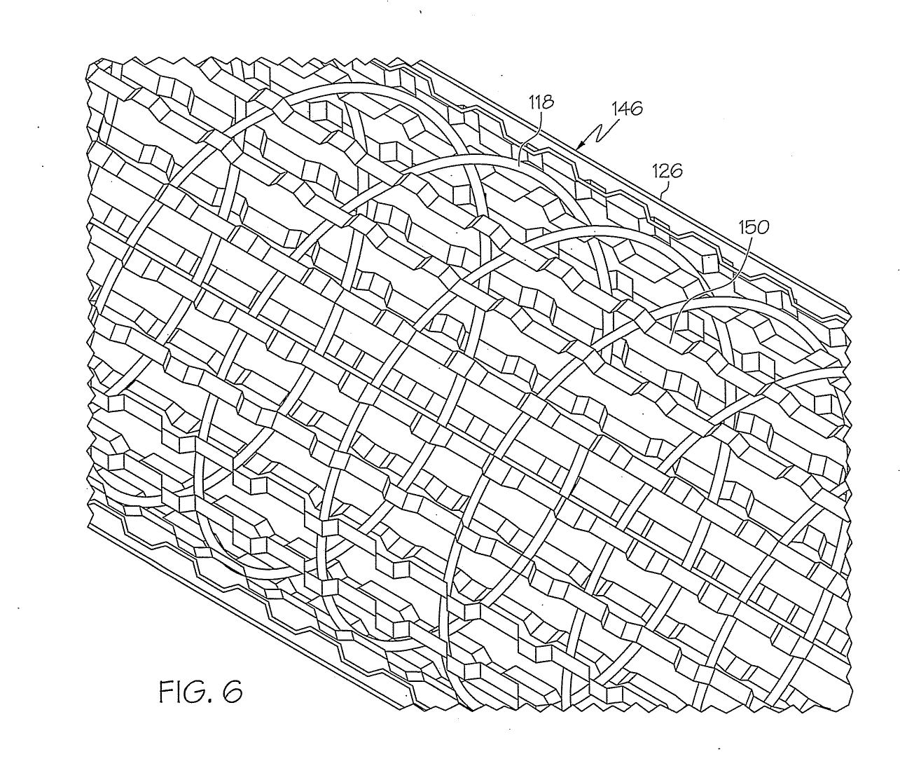

Referring to FIG. 6, an alternate embodiment of the fiber optic cable downhole tool mounting system 100 routes the fiber optic cable 118 within the radial extremes of the shroud 126. The shroud 126 of this embodiment includes an outer shell 146 with a plurality of teeth 150 that protrude radially inwardly from the outer shell 146. By sizing an outer diameter of the fiber optic cable 118 so that it is less than the height of the teeth 150 the fiber optic cable 118 is able to fit entirely within the gaps formed by adjacent teeth 150. Additionally, by spacing the teeth 150 to correspond with dimensions of a helical pattern the fiber optic cable 118 can be routed between teeth 150 without interfering with the teeth 150. Stated another way, the parameters of the helical pattern can be set such that the fiber optic cable 118 does not interfere with the teeth 150. As with other embodiments, the strain transmissivity mounting of the fiber optic cable 118 within the mounting system 100 is by way of swaging of the shroud 126, fiber optic cable 118 and other components of the screen assembly 114 radially toward the base pipe 130. Alternate embodiments, however, could strain transmissivity mount the fiber optic cable 118 to the mounting system 100 with mechanical interference provided by other than swaging.

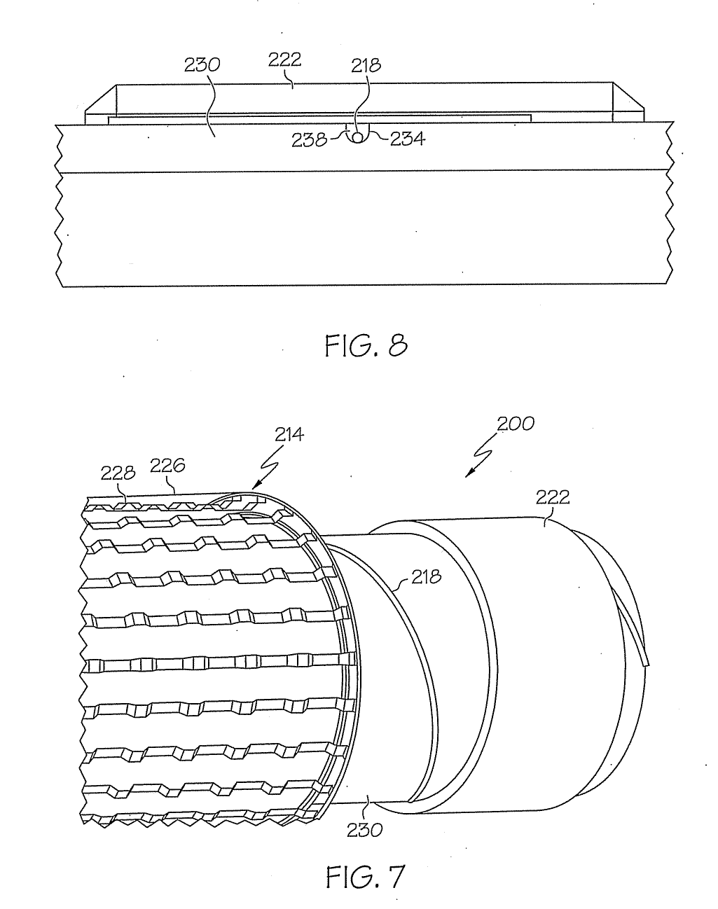

Referring to FIGS. 7 and 8 an embodiment of the fiber optic cable downhole tool mounting system 200 includes a screen assembly 214 with a fiber optic cable 218, an end ring 222. The screen assembly 214 has a shroud 226, filter media 228 and a base pipe 230. In this embodiment the base pipe 230 has a helical channel 234 formed therein at an angle that is chosen per the requirements of the particular application. An adhesive 238 such as epoxy, for example, adheres the fiber optic cable 218 to the base pipe 230 within the channel 234. The shroud 226 and the weldless end rings 222 are sealably engaged to the base pipe 230 by swaging.

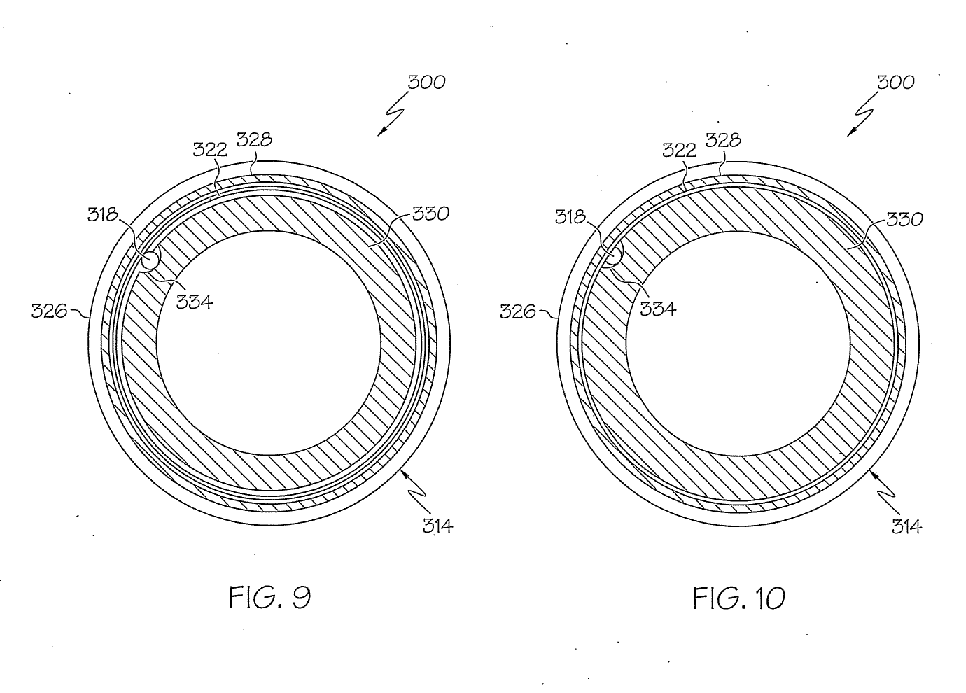

Referring to FIGS. 9 and 10, an embodiment of the fiber optic cable downhole tool mounting system 300 includes a screen assembly 314 with a fiber optic cable 318, and an end ring (not shown). The screen assembly 314 includes a sleeve 322, a shroud 326, a screen cartridge 328 and a base pipe 330. The base pipe 330 is radially outwardly swagable and has a helical channel 334 formed therein at an angle that is chosen per the requirements of the particular application. An outer dimension, such as a diameter in the case of a circular cross section, of the fiber optic cable 318 is greater than the radial depth of the channel 334 for reasons that will be clarified below. An outer dimension of the base pipe 330 prior to being swaged is smaller than an inner dimension of the sleeve 322, which is in axial alignment with the base pipe 330. The fiber optic cable 318 is positioned in the channel 334 and the base pipe 330 is positioned within the sleeve 322 before the base pipe 330 is swaged. The screen cartridge 328 and the shroud 326 have greater radial dimensions than the sleeve 322 and the base pipe 330 and are positioned in axial alignment with the base pipe 330, as is the end ring. A swaging operation radially expands the base pipe 330 such that after swaging the base pipe 330 is mechanically locked and sealingly engaged to the sleeve 322, the fiber optic cable 318, the end ring, the screen cartridge 328 and the shroud 326. The fiber optic cable 318 is also mechanically locked to the base pipe 330 due to being radially compressed in the channel 334 between the base pipe 330 and the sleeve 322. The mechanical compression of the fiber optic cable 318 assures that the fiber optic cable 318 senses parameters such as stress encountered by the screen assembly 314. Any sensed parameter imparted on the fiber optic cable 318 by the swaging process can be calibrated to zero.

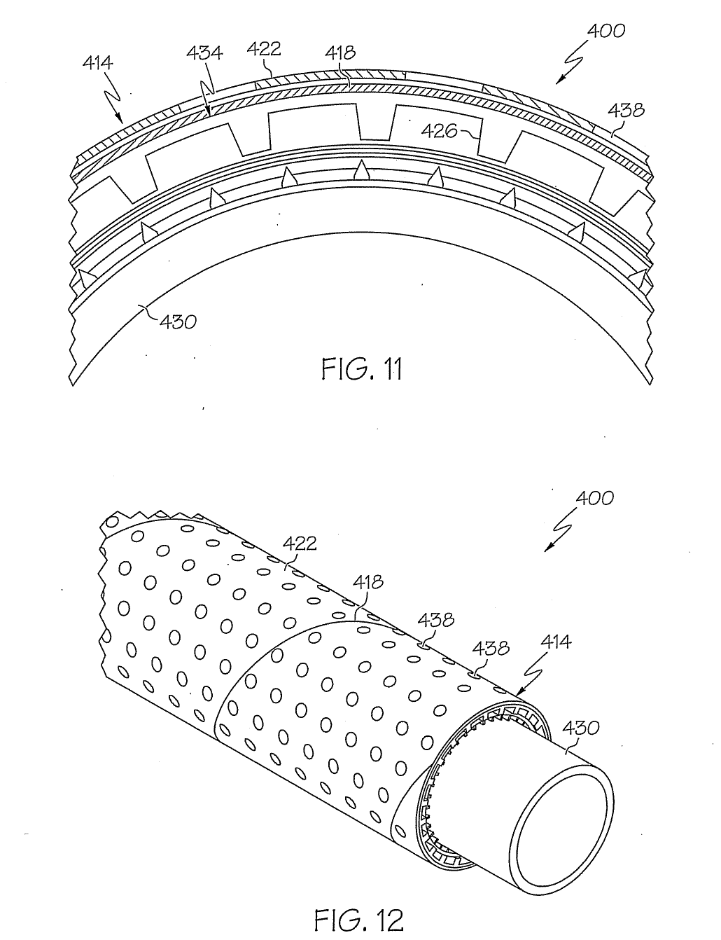

Referring to FIGS. 11 and 12 an alternate embodiment of the fiber optic cable downhole tool mounting system 400 is illustrated. The mounting system 400 includes a screen assembly 414 that has among other things a fiber optic cable 418, a support sleeve 422, a shroud 426 and a base pipe 430. The fiber optic cable 418 is routed in a helical fashion around an outer surface 434 of the shroud 426. An inner diameter of the support sleeve 422 is sized such that the support sleeve 422 fits around the shroud 426 with the fiber optic cable 418 positioned on the outer surface 434. The support sleeve 422, the fiber optic cable 418 and the shroud 426 are swaged to mechanically lock the support sleeve 422 with the fiber optic cable 418 and the shroud 426 to the base pipe 430.

Additionally, it may be desirable to position the fiber optic cable 418 so as not to be in radial alignment with any of a plurality of apertures 438 through the support sleeve 422 or a plurality of apertures (not shown) through the shroud 326. Such positioning might be desirable to avoid obstructing fluid flow through the apertures 438, since such obstruction could have a detrimental affect on production of the well and could render the tool 400 susceptible to flow cutting of the fiber optic cable 418.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A fiber optic cable downhole tool mounting system, comprising:
a downhole tool;
a support member attached to the downhole tool; and
a fiber optic cable parameter transmissively mounted to the downhole tool by the support member, the support member having an elongated body with a pair of legs extending therefrom, the pair of legs intersecting at an oblique angle and defining a volume therebetween receptive of the fiber optic cable, the fiber optic cable being attachable to the support member and the support member being attachable to the downhole tool such that a parameter encountered by the downhole tool is sensible by the fiber optic cable.

2. The fiber optic cable downhole tool mounting system of claim 1, wherein the downhole tool is a screen assembly.

3. The fiber optic cable downhole tool mounting system of claim 1, wherein the parameter is strain.

4. The fiber optic cable downhole tool mounting system of claim 1, wherein the fiber optic cable and the support member are attached to the downhole tool in a helical pattern.

5. The fiber optic cable downhole tool mounting system of claim 1, wherein a radially outermost layer of the downhole tool is a shroud and the support member is attached to the shroud at a radially outwardly facing surface thereof.

6. The fiber optic cable downhole tool mounting system of claim 5, wherein the support member and the fiber optic cable are routed so as to avoid being in radial alignment with any one of a plurality of apertures in the shroud.

7. The fiber optic cable downhole tool mounting system of claim 1, wherein the fiber optic cable includes a sheath.

8. The fiber optic cable downhole tool mounting system of claim 7, wherein the sheath is metal.

9. The fiber optic cable downhole tool mounting system of claim 1, wherein the fiber optic cable is attached to the support member by adhesive bonding.

10. The fiber optic cable downhole tool mounting system of claim 1, wherein the fiber optic cable is attached to the support member by welding.

11. The fiber optic cable downhole tool mounting system of claim 1, wherein the fiber optic cable is attached to the support member by swaging.

12. The fiber optic cable downhole tool mounting system of claim 1, wherein the fiber optic cable is attached to the support member by interference fitting.

13. The fiber optic cable downhole tool mounting system of claim 1, wherein the support member is attached to the downhole tool by adhesive bonding.

14. The fiber optic cable downhole tool mounting system of claim 1, wherein the support member is attached to the downhole tool by welding.

15. The fiber optic cable downhole tool mounting system of claim 1, wherein the support member is attached to the downhole tool by swaging.

16. The fiber optic cable downhole tool mounting system of claim 1, wherein the attachment of the support member to the downhole tool is through the elongated body.

17. The fiber optic cable downhole tool mounting system of claim 1, wherein the attachment of the support member to the downhole tool is through one of the legs.

18. The fiber optic cable downhole tool mounting system of claim 1, wherein the support member urges the fiber optic cable against the surface of the shroud.

19. The fiber optic cable downhole tool mounting system of claim 1, wherein the fiber optic cable is sensitive to at least one of stress, strain, temperature, seismic activity, chemical composition, pressure and combinations including at least one of the foregoing.

20. A fiber optic cable downhole tool mounting system, comprising
a downhole tool;
an elongated support member with two legs extending from a body at an obtuse angle to one another, at least one of the legs being attached to the downhole tool such that the body is positioned at a greater radial dimension from an axis of the downhole tool than radial dimensions of the legs thereby defining a volume between the support member and the downhole tool; and
a fiber optic cable strain sensibly mountable within the volume between the support member and the downhole tool such that the fiber optic cable senses strain encountered by the downhole tool.

21. A fiber optic cable downhole tool mounting system, comprising:
a base pipe;
a shroud in axial alignment with the base pipe positionable radially outwardly of the base pipe;
at least one tubular member positionable within an annular space between the base pipe and the shroud; and
a fiber optic cable positionable in an annular space between the base pipe and the shroud, the fiber optic cable being strain transmissively mountable to the downhole tool through interference of the fiber optic cable with at least two of the base pipe, the shroud and the at least one tubular member.

22. The fiber optic cable downhole tool mounting system of claim 21, wherein the shroud and the tubular member are swagable and the interference is generated when the shroud and the tubular member are swaged.

23. The fiber optic cable downhole tool mounting system of claim 21, wherein the base pipe is swagable and the interference is generated when the base pipe is swaged.

24. The fiber optic cable downhole tool mounting system of claim 21, wherein the fiber optic cable is mountable to the tool in a helical pattern.

25. The fiber optic cable downhole tool mounting system of claim 21, further comprising at least one end ring in axial alignment with the base pipe and positionable radially outwardly of the base pipe and the fiber optic cable with reference to an axis of the base pipe, the at least one end ring being sealably engagable with the base pipe and the fiber optic cable in response to the base pipe being swaged.

26. The fiber optic cable downhole tool mounting system of claim 21, further comprising at least one end ring in axial alignment with the base pipe and positionable radially outwardly of the base pipe and the fiber optic cable with reference to an axis of the base pipe, the at least one end ring being sealably engagable with the base pipe and the fiber optic cable in response to the at least one end ring being swaged.

27. The fiber optic cable downhole tool mounting system of claim 21, wherein swaging of the shroud generates the interference between the tubular member, the fiber optic cable and the base pipe.

28. The fiber optic cable downhole tool mounting system of claim 21, wherein the fiber optic cable includes a protective sheath.

29. The fiber optic cable downhole tool mounting system of claim 28, wherein the protective sheath is metal.

30. The fiber optic cable downhole tool mounting system of claim 21, further comprising at least one sleeve positionable within the annular space between the base pipe and the swagable member, the at least one sleeve abutting the fiber optic cable.

31. The fiber optic cable downhole tool mounting system of claim 21, further comprising a channel formed in an outer surface of the base pipe the fiber optic cable being positionable within the channel.

32. The fiber optic cable downhole tool mounting system of claim 31, further comprising an adhesive for attaching the fiber optic cable to the channel.

33. The fiber optic cable downhole tool mounting system of claim 21, wherein the fiber optic cable is routable so as to avoid being in radial alignment with any one of a plurality of apertures in the shroud.

34. A fiber optic cable downhole tool mounting system, comprising:
a base pipe;
at least one tubular member in axial alignment with the base pipe positionable radially outwardly of the base pipe;
a shroud positioned within an annular space between the base pipe and the at least one tubular member; and
a fiber optic cable positionable in an annular space between the base pipe and the at least one tubular member, the fiber optic cable being strain transmissively mounted to the downhole tool through interference of the fiber optic cable with at least two of the base pipe, the shroud and the at least one tubular member.

35. The fiber optic cable downhole tool mounting system of claim 34, wherein the fiber optic cable is positioned radially outwardly of the shroud.
